(19) United States
(12) Patent Application Publication
(10) Pub. No.: US 2015/0082351 A1
(43) Pub. Date: Mar. 19, 2015

(54) METHOD AND SYSTEM FOR COLLECTING AND VALIDATING CHANNEL LINEUP AND MODULATION DATA WITH IMPROVED ACCESSIBILITY TO MULTIPLE TYPE CHANNELS WITH AUTOMATIC CORRECTION

(71) Applicant: Samsung Electronics Co., Ltd., Suwon-si (KR)

(72) Inventors: Praveen Kashyap, Irvine, CA (US); Toshiro Ozawa, Irvine, CA (US); Jing Zhang, Irvine, CA (US); Ashish Singhal, Irvine, CA (US); Feng Xu, Irvine, CA (US); Shiangfeng Lee, Irvine, CA (US)

(21) Appl. No.: 14/449,086

(22) Filed: Jul. 31, 2014

Related U.S. Application Data
(60) Provisional application No. 61/877,861, filed on Sep. 13, 2013.

(51) Int. Cl. H04N 21/239; H04N 21/654; H04N 21/482; H04N 21/462; H04N 21/431; H04N 21/643; H04N 21/258; H04N 21/222

(52) U.S. Cl. CPC H04N 21/239; H04N 21/25808; H04N 21/654; H04N 21/2221; H04N 21/4622; H04N 21/462; H04N 21/431; H04N 21/64322; H04N 21/4821; H04N 21/4823
USPC 725/44; 725/116; 725/49

(57) ABSTRACT

A method includes identifying a first headend that is connected to one or more receivers. The receivers are assigned to a particular priority set of many priority sets for the identified first headend.

### CROSS-REFERENCE TO RELATED APPLICATIONS

This application claims the priority benefit of U.S. Provisional Patent Application Ser. No. 61/877,861, filed Sep. 13, 2013, which is incorporated herein by reference in its entirety.

### TECHNICAL FIELD

One or more embodiments relate generally to television networks and, in particular, to prioritizing receivers connected to headends, providing a single viewing interface for radio frequency (RF) sources and Internet Protocol (IP) sources, and dynamically validating and correcting commercial television metadata resources.

### BACKGROUND

There are about 13,000 headends in the United States (US). On an average, the channel map changes about twice a year on a headend. There are about 1,700 television (TV) stations in the US and many thousands of low power stations. New stations may be added online, stations may change ownership, and some may stop transmission from time to time. The channel map that is obtained from Rovi or other sources (Channel map source) has between 2% to 5% errors.

Some local channels that only broadcast a few hours a day, may share the same channel number. This could lead to channel map changes several times a day. Some multiple system operators (MSOs) (e.g., TWC, Cox, etc.) have switched digital video (SDV) to optimize the cable plant usage. Some of the lesser watched channels are transmitted as SDV. Whenever a switched digital channel starts, a new entry is made in the channel map. This leads to very frequent changes (e.g., several hundred a day).

Display devices such as TV sets with Internet connection capability, may receive content from RF Cable via TV tuner (OTA and ClearQAM), IP (Ethernet or Wi-Fi) and High-Definition Multimedia Interface (HDMI) (e.g., set top box (STB), digital television adapter (DTA)). Conventionally, content from these sources are shown as disparate experience (Apps) with their own navigation, such as Electronic Program Guide (EPG). This is because content sources may be controlled by different business entities. For example, the tuner is not capable of receiving encrypted channels such that the TV cannot receive all subscribed channels. Further, different content sources have different channel numbering schemes. Additionally, metadata from various sources is different and has inaccuracies and missing information. For example, the metadata (e.g., channel name or program name) coming as a part of the content (MPEG PES and PSIP tables) and from metadata companies (Rovi, TMS, etc.) all have missing or inaccurate information and do not relate across each other.

Majority of TV viewers (such as in North America) receive TV signals from the Pay TV operators. The number of channels available to a subscriber depends on the subscription tier (e.g., limited basic, extended basic or premium). Additionally, some channels can be purchased independently. Almost all Pay TV channels are encrypted, although some cable TV channels (limited basic that includes broadcast and local channels) are not encrypted (ClearQAM). The encrypted channels are only viewable using a Cable company STB or a Cable Card based retail device (TV or set-top box (STB)), but the ClearQAM channels can be viewed on a TV just as over the air (OTA) broadcast channels. Metadata companies provide EPG for all broadcast and Multiprogramming Video Programming Distributor (MVPD) channel lineups, not for ClearQAM channels.

Commercial TV data resources, such as Rovi, sometimes have mismatchings in channel lineup or Electronic program guide (EPG). Generally, Rovi has reliable information on popular channels, such as ABC or FOX. However, it still suffers from lack of information or update from domestic and seasonal channels. EPG providers outside the United States, such as RedBee for Europe market, have even higher error ratio than Rovi as the metadata market is not as mature as that in the US.

### SUMMARY

In one embodiment, a method includes prioritizing receivers connected to a headend. In one embodiment, the method includes identifying a first headend that is connected to one or more receivers. The receivers are assigned to a particular priority set of many priority sets for the identified first headend.

One embodiment provides a system for assigning priorities to receivers connected to headends. One embodiment comprises one or more headend devices and one or more receivers coupled to the one or more headends. In one embodiment, the one or more receivers identify a first headend that is coupled to the one or more receivers, and forward information based on the identified first headend to a service. The service assigns the one or more receivers to a particular priority set of a plurality of priority sets for the identified first headend.

Another embodiment provides a non-transitory computer-readable medium having instructions which when executed on a computer perform a method comprising: identifying a first headend that is coupled to one or more receiver devices. In one embodiment, one or more receivers are assigned to a particular priority set of a plurality of priority sets for the identified first headend.

These and other aspects and advantages of the embodiments will become apparent from the following detailed description, which, when taken in conjunction with the drawings, illustrate by way of example the principles of the embodiments.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 shows an example cable headend and receiver hierarchy.

FIG. 2 shows an example of priority sets associated with each single headend, according to an embodiment.

FIG. 3 shows an example flow diagram for adding a receiver to a priority set, according to an embodiment.

FIG. 4 shows an example flow diagram for treatment of priority-2 or higher priority receivers, according to an embodiment.

FIG. 5 shows example views of a cable STB and OTA receiving the same channel.

FIG. 6 shows example views of a cable STB and TV receiving the same clear QAM channel.

FIG. 7 shows an example flow diagram for combining programming from OTA and IP, according to an embodiment.

FIG. 8 shows an example flow diagram for combining programming from Clear QAM and IP, according to an embodiment.

FIG. 9 shows an example flow diagram for a modified auto-programming of a regular TV set with channel map replacement, according to an embodiment.

FIG. 10 shows a block diagram of a TV device in which embodiments are implemented in an access module, according to an embodiment.

FIG. 11 shows an example data transmission flow in content generation and correction, according to an embodiment.

FIG. 12 shows an example distributed system that may implement one or more embodiments.

FIG. 13 shows a flow diagram for lineup validation and correction, according to an embodiment.

FIG. 14 shows a flow diagram for EPG validation and correction, according to an embodiment.

FIG. 15 shows a flow diagram for test matching with metadata, according to an embodiment.

FIG. 16 is a high level block diagram showing a computing system useful for implementing an embodiment.

### DETAILED DESCRIPTION

The following description is made for the purpose of illustrating the general principles of the embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments of relate generally to prioritizing receivers connected to one or more headends, providing a single viewing interface (e.g., navigator, electronic programming guide (EPG), etc.) for over the air (e.g., RF) content channels and Internet protocol (IP) content, and correcting metadata for the single viewing interface if required. One embodiment provides for a method includes prioritizing receivers connected to a headend. In one embodiment, the method includes identifying a first headend that is connected to one or more receivers. The receivers are assigned to a particular priority set of many priority sets for the identified first headend.

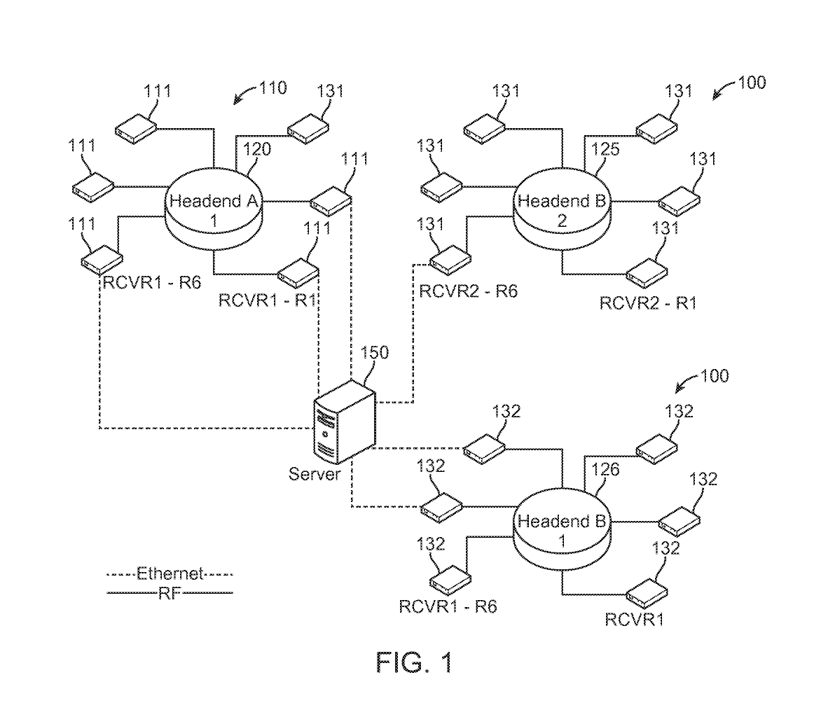

FIG. 1 shows an example cable headend and receiver hierarchy. Headend A 1 120 in a provider network or cable plant 110 is connected with several receivers 111 (Rcvr1 R1-R6); headend B 1 126 in a provider network or cable plant 100 is connected to several receivers 132 (Rcvr1 R1-R6); and headend B 2 125 in an additional provider network or cable plant 100 is connected with several receivers 131 (Rcvr2 R1-R6). The number of receivers on a headend is not known a priori and the number can change at any time. Also, the network connection is not guaranteed and the receiver set top box (STB) or other type of receiver, or the network can fail at any time.

The channel maps for provided content and other cable plant information for all receivers on one headend is the same (e.g., all receivers 111 on headend A 1 120 have the same channel map, all the receivers 132 on headend B 1 126 have the same channel map, etc.). A channel map includes a table of channel information of all available channels in a cable headend system. Each channel information may include the following:
(1) Virtual channel number: up to 4-digit solid number for Cable (2, 1015, etc.) or combination of major and minor numbers for ATSC (7.1, 123.456, etc.);
(2) channel name or call sign: e.g., KCBS, CNN, ESPN2 HD, etc.;
(3) physical channel number: a 3-digit number which defines the tuning frequency to select a multiplex, or transport stream;
(4) program number: a 16-bit number to select a program (a TV channel) from the multiplex; and
(5) Modulation type (QAM 256, VSB 8, etc.).

The changes to the cable plant information are simultaneously reflected in all its receivers. The receivers 111, 131 and 132 and the network connectivity with the respective headends may be unreliable due to congestion, failures, etc. In one embodiment, a server or service 150 may be connected to particular or all receivers 111, 131 and 132 for receiving information and assigning priorities.

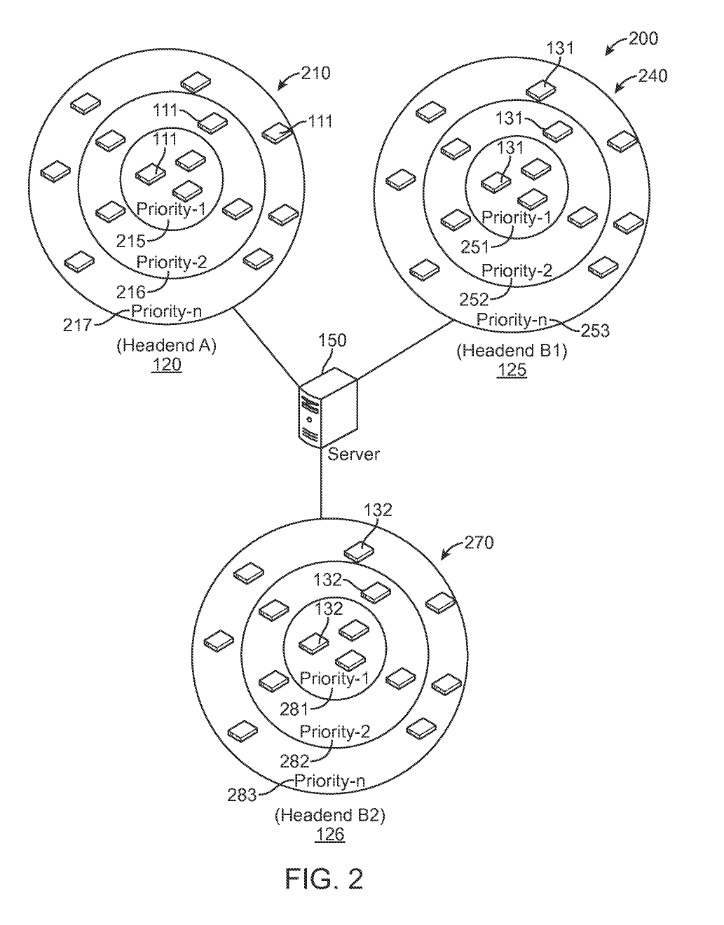

FIG. 2 shows an example 200 of priority sets associated with each single headend, according to an embodiment. In one embodiment, headend A 120 has a priority hierarchy 210 for the receivers 111, headend B1 125 has a priority hierarchy 240 for receivers 131, and headend B2 126 has a priority hierarchy 270 for the receivers 132. In one example, a priority hierarchy of receivers is attached to each single headend. This is represented as groups or sets. In one example, priority hierarchy 210 includes priority-1 set 215, priority-2 set 216 to priority-n set 217; priority hierarchy 240 includes priority-1 set 251, priority-2 set 252 to priority-n set 253; and priority hierarchy 270 includes priority-1 set 281, priority-2 set 282 to priority-n set 283.

In one embodiment, the number of the priority sets (e.g., priority-1, priority-2, . . . priority-n) is dynamic and may be changed at any time (e.g., via the server or service 150), although a typical or preferred number may be three (3). In one example, the membership of the priority sets is dynamic and may be changed by the server or service 150 at any time. In one embodiment, the size or number of receivers in the priority sets might be 2-5 receivers for priority-1 (e.g., priority-1 215, 251, and 281), 5-100 receivers for Priority-2 (e.g., 216, 252 and 282) and 100-100,000 (or more) for Priority-3 (e.g., 217, 253 and 283).

In one or more embodiments, the priority sets serve multiple purposes. In one example, for priority-1, the receivers report the channel map and other cable plant information to the server or service 150. The frequency with which each receiver reports to the server or service 150 is considered high (e.g., once an hour). In one example, the frequency of reporting for priority-1 may be based on a map change, or a report of “No change” if there is no change in the channel map information within a particular time period.

In one embodiment, for priority-2 and higher (e.g., priority-3 to priority-n), the receivers do not report any information but just send an alive (e.g., a heartbeat) message. In one example, the frequency with which the receivers in a priority-2 and higher set send these messages reduces as the priority increases. For example, a priority-2 set the associated receivers (e.g., uni-directional cable receivers (UDCRs)) may send a heartbeat message once a day; Priority-3 associated receivers may send a heartbeat message once a month, etc.

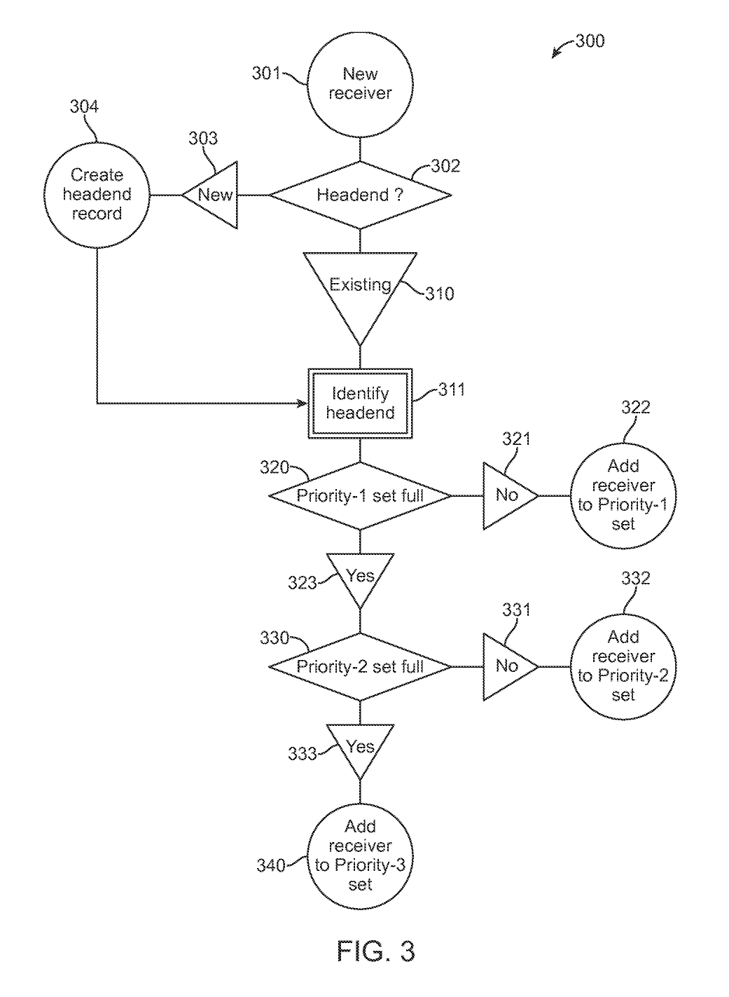

FIG. 3 shows an example flow diagram 300 for adding (or associating) a receiver to a priority set, according to an embodiment. In one example, at the start of the flow diagram 300, a new receiver is available for being added to a priority set at block 301. At block 302 it is determined if a headend is a new or existing headend for a cable plant. In one embodiment, if the headend is determined to be a new headend at block 303, the flow continues from block 303 to block 304 where a headend record or information is created. If the headend is determined to be an existing headend at block 310, the flow continued from block 310 to block 311, where the headend is identified.

In one embodiment, in block 320 it is determined if the priority-1 set of receivers is full or not (e.g., a particular or selected maximum of membership number of receivers is met). If the result of the determination is no at block 321, the flow proceeds to block 322 where the new receiver is added to the priority-1 set. If it is determined that the priority-1 set of receivers is full at block 323, the flow proceeds to block 330 where it is determined whether the priority-2 set of receivers is full or not.

If the result of the determination of block 330 is no at block 331, the flow proceeds to block 332 where the new receiver is added to the priority-2 set. If it is determined that the priority-2 set of receivers is full at block 333, the flow proceeds to block 340 where the receiver s added to the priority-3 set. It should be noted that if higher priority sets exist, the flow 300 continues checking priority sets for the membership being full or not and adding the receiver appropriately.

In one embodiment, for a receiver that is disconnected or has moved and a network is bad (e.g., latency, interference, errors, etc.), for a receiver in a priority-1 set that fails to send (report) the channel map or a “No change” message, and a priority-2 or higher set fails to send a heartbeat for a particular number of periodic intervals or time periods (e.g., 2-3 intervals), it is assumed to be disconnected and the receiver is removed from the receiver database.

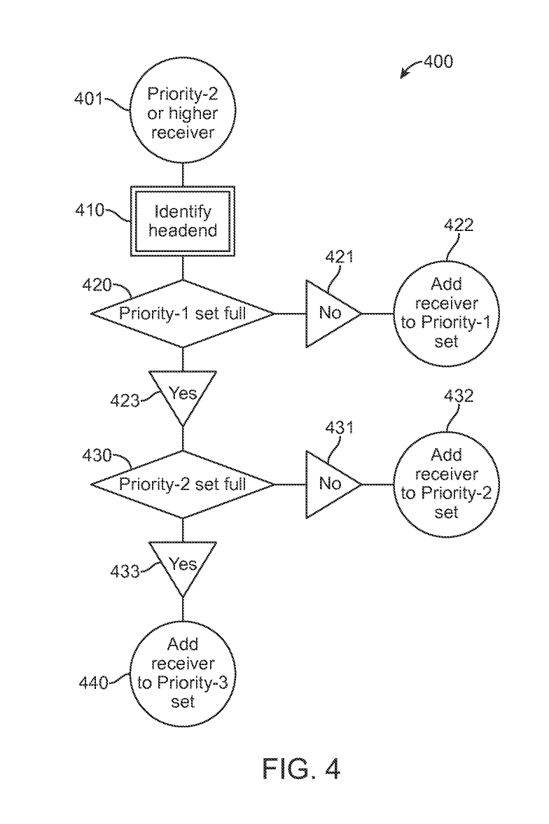

In one example, a receiver from a priority-1 set may be placed/associated in a higher (or highest) priority set if the receiver has demonstrated unreliable behavior, or sending incorrect data for any reason. In another example, for a receiver associated or within a priority-2 or higher set, when the receiver sends a heartbeat, the server or service 150 (FIG. 2) checks to see if the priority-1 set of its headend has a full membership (see, e.g., FIG. 4). If the Priority-1 set does not have a full membership (e.g., if a priority-1 set receiver is disconnected or moved), the server or service 150 assigns the receiver to the priority-1 set. If the priority-1 set has a full membership, the server or service does the same check with priority-2 and higher sets.

FIG. 4 shows an example flow diagram 400 for treatment of priority-2 or higher priority receivers, according to an embodiment. In one embodiment, a receiver is currently associated or within a priority-2 or higher set at block 401. In block 410, the headend of the receiver is identified. In one embodiment, in block 420 it is determined if the priority-1 set has a full membership. If it is determined at block 421 that the priority-1 set does not have a full membership, the flow proceeds to block 422 where the receiver is added to the priority-1 set. If it is determined at block 423 that the priority-1 set has a full membership, then the flow proceeds to block 430.

In one embodiment, in block 430 it is determined if the priority-2 set has a full membership. If it is determined at block 431 that the priority-2 set does not have a full membership, then the flow proceeds to block 432 where the receiver is added to the priorty-2 set. If it is determined at block 433 that the priority-2 set does have a full membership, the flow proceeds to block 440 where the receiver is added to the priorty-3 set.

In one embodiment, a receiver may first contact the server or service 150 (FIG. 2) when it is booted or starts up. In one example, it may be assumed that this starting event is random (e.g., across the universe of receivers) and no attempt is made to synchronize it with anything else. This is done to maintain a balanced server or service 150 load. If the server or service 150 shows non uniform load (with peaks), some receivers which are reporting at peak times may be pushed to higher priority sets.

In one example, assuming that there is no way to identify the headend or cable plant, a one-way hash (e.g., SHA 1) over the channel map that a receiver reports. Assuming that there is no transmission error, all receivers on a single headend should have the same channel map at one time instance, and therefore the same one-way hash. In one example, a one-way hash is used to optimally identify a headend and create a headend group (e.g., headend A 120 priority hierarchy 210, FIG. 2).

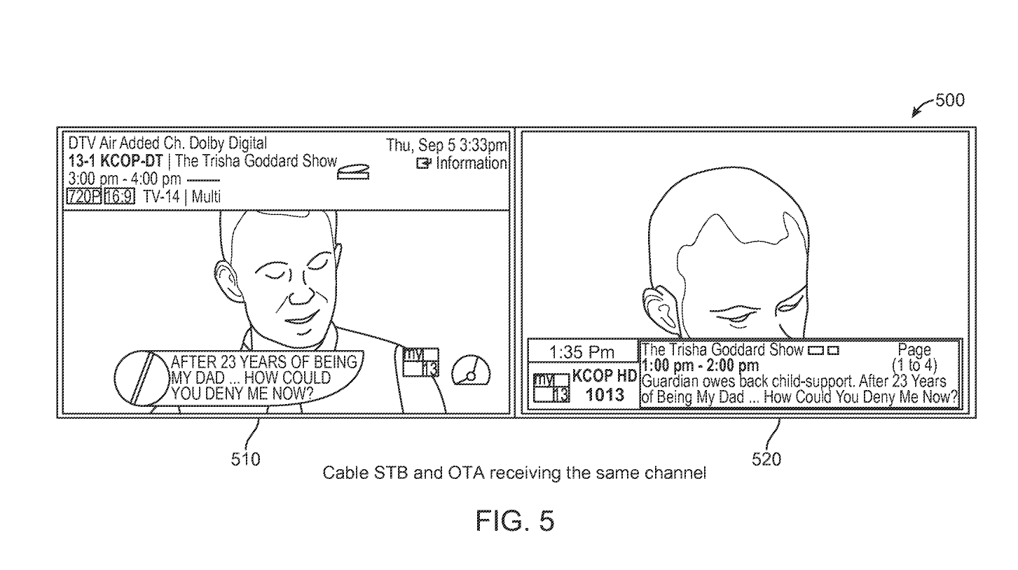

FIG. 5 shows example views 500 of a cable STB 510 and OTA 520 receiving the same channel. In one embodiment, screen view 510 is displaying the output from an OTA channel and is showing channel 13-1 and the channel name KCOP-DT. The screen view 520 is the same channel from another source (e.g., Cox cable STB) although the channel number is 1013 and the name is KCOP HD. Cable TV virtual channel numbers are delivered Out-of-band and are only available on Cable STBs or retail devices with a Cable Card. The format of this data is defined by the SCTE 65 standard (e.g., SCTE 65 SERVICE INFORMATION DELIVERED OUT-OF-BAND FOR DIGITAL CABLE TELEVISION; and ATSC: Program and system information protocol that describes the MPEG tables). The STB may retrieve this data using the method defined in the Cable Card Interface 2.0 Specification. TV sets receiving ClearQAM video cannot obtain this information from the Cable MSO. Therefore, the same set of channels received by a ClearQAM TV set will have a different numbering scheme from an STB or Cable Card device.

Broadcast channels have MPEG tables that carry ATSC style channel number and these MPEG tables are usually carried by the MSOs without change. MSOs also carry other channels (non-broadcast) in the clear and they do not have assigned channel numbers. In these cases, TVs will assign channel numbers locally using their own rule set by each TV manufacturer. As a result, channel numbers are very different between leased STBs and the TVs using ClearQAM, although the actual channel lineup of the TV is a subset of what an STB can receive.

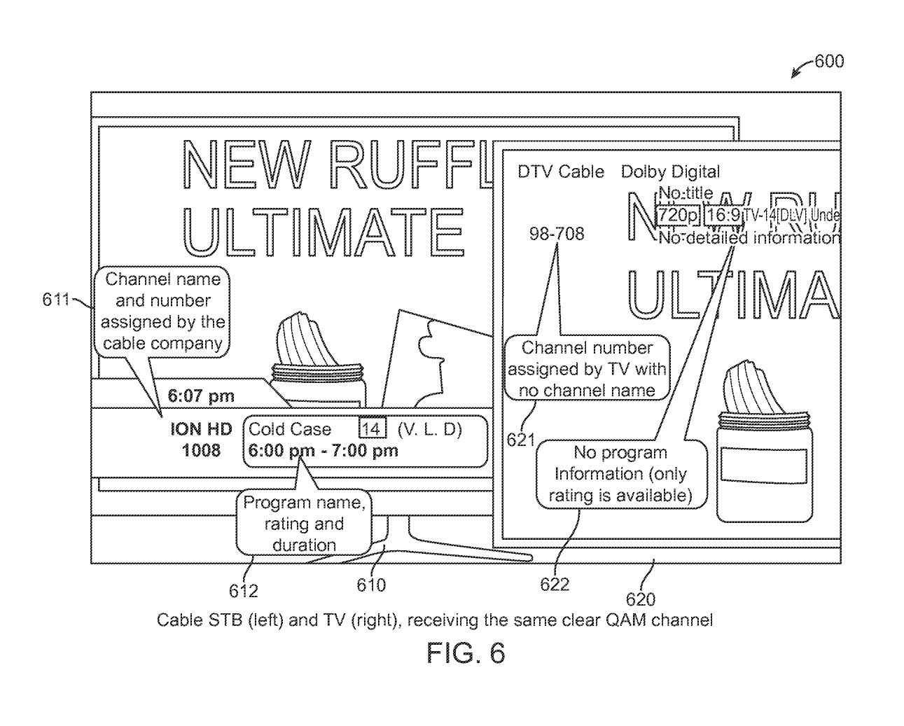

FIG. 6 shows example views 600 of a cable STB and TV receiving the same clear QAM channel. The view 610 is displaying the output from a cable STB. The channel name and number 611 is assigned by the cable/satellite provider. The program name, rating and duration (612) is also displayed.

The view 620 is showing a channel tuned by the internal TV tuner. The channel number assigned by the TV 621 is displayed without a channel name. No program information is displayed. Only the rating 622 is available.

The two television views 610 and 620 are receiving the same content (same digital channel tuned with the same carrier frequency and the program number). However, the banner display (channel number, channel name, duration, and rating) is very different.

Embodiments disclosed herein provide processes and systems for electronic devices (e.g., TVs), services or servers with improved accessibility to cable, broadcast and IP channels. One embodiment provides a unified view of LiveTV programming or content for one or more of: (1) television manufacturer applications or viewing interfaces (e.g., Samsung experience (Only), Content provider experience using an App, etc.); (2) content from various sources including RF cable and IP; and (3) one navigator or EPG per experience build using data provided by Metadata Company MPEG tables, URIs, etc.

One or more embodiments allow creation of a single channel map by gathering information from one or more sources (Metadata companies, MPEG tables, and URIs. This includes using the channel numbers assigned by MVPDs (or other standard) to the channels that a TV can receive from RF Cable (OTA or ClearQAM). For example, a channel up/down button shows the next channel regardless of the content source. The new channel map may be imported from another device or cloud storage, which have access to cable-supplied channel map. In case of multiple video sources for the same video program, one or more embodiments allow navigation to a video program based on the business rules. For example, if the same video program is available from both RF and IP, select the RF source since it is less expensive and delivers better quality.

One embodiment obtains a cable channel map from a Cable Card device. The channel map is stored in every cable STB or Cable Card device in a local environment, such as a home environment. One implementation includes an STB or Cable Card device with the channel map accessible from another device, or perform uploading of the channel map data periodically to a cloud storage (e.g., remote server), which is accessible from a client (TV).

In one embodiment, the Channel map may be imported using the network (Internet) connection, wherein the electronic device imports channel map data in one or more of the following ways:
(1) discover a device with an accessible channel map in the home network;
(2) discover a device with an accessible channel map outside home network, but in the same cable headend system; and
(3) access the data server in the cloud and find the channel map matching the headend that it belongs to, e.g., with zip code and cable provider name.

The actual process of discovery may be based on standards for device discovery (e.g., UPnP) within the local network. Depending on the video source, the metadata needed to create the channel lineup is different. Two example applications are provided below for illustration purposes, however, embodiments are useful in other applications as well.
1. For content partner Apps: the content is received from OTA or ClearQAM sources and is augmented with content received over IP. The channel map is received from the content provider and it may be the same (or similar) as what is displayed from an STB. This is a cost efficient option for secondary TVs without using an STB while receiving high quality OTA or ClearQAM content. This application is also very appealing to MVPDs if content is received over OTA as the fees for retransmission rights may be avoided.
2. In TV manufacturers implementations (e.g., OnTV): content is received from a cable MSO (e.g., ClearQAM) using an RF cable and EPG data from a metadata provider. By using the channel map from the cable or satellite company, a user can access all the unencrypted channels with the same channel numbers that the user views on their cable/satellite STB. Although the TV cannot receive the encrypted channels like an STB, it can still receive content over IP as it becomes more popular. This application may be a cost-efficient option for secondary TVs in the home or local environment without the need of leasing another STB.

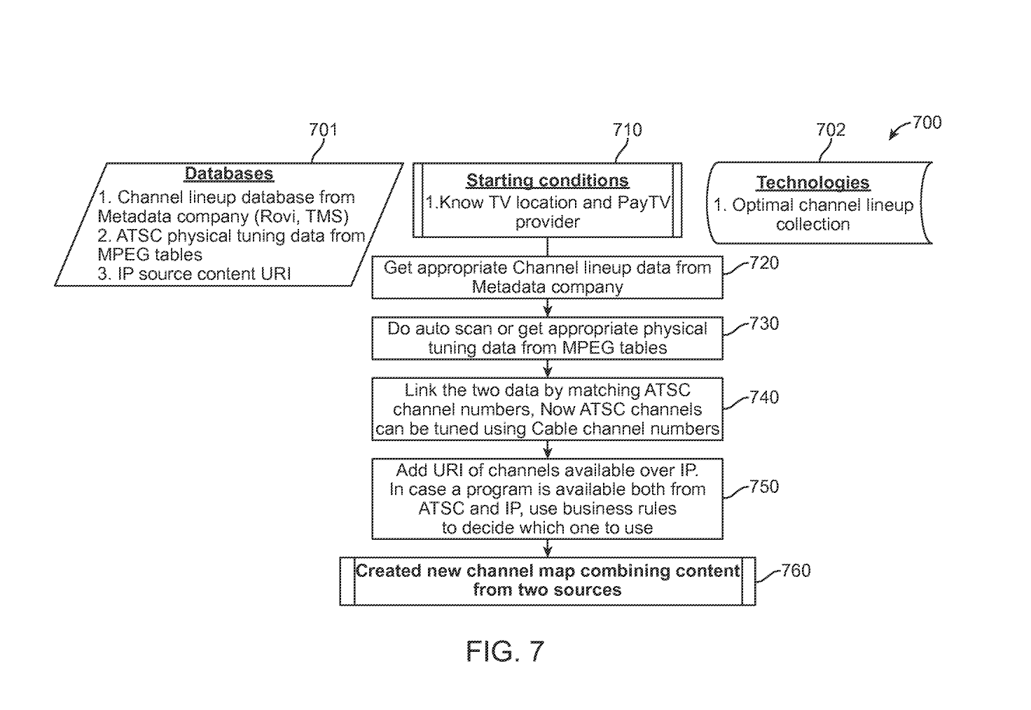

FIG. 7 shows an example flow diagram 700 for combining programming from OTA and IP, according to an embodiment. In one example, the databases 701 may include a channel lineup database from a metadata company (e.g., Rovi, TMS), ATSC physical tuning data from MPEG tables, and IP source content URIs. In one example, starting conditions 710 may include knowing a TV's location and the pay TV provider. In one example, technologies 702 may include optimal channel lineup collections. In one embodiment, in block 720 appropriate channel lineup data is obtained from a metadata company. In block 730, an auto-scan or physical tuning data is obtained using the electronic device based on MPEG tables. In block 740 different sets of data are linked by matching ATSC channel numbers. This results in ATSC channels being tuned using cable channel numbers. In one embodiment, in block 750 URIs of channels available over IP are added. In case program is available both from ATSC and IP, business rules are used to decide which one to use. In block 760, the newly created channel map combining content from two different sources is created.

TVs connected to an Antenna can receive OTA programming, where the number of channels received depends on the location of the TV and transmitter signal strength. The OTA physical tuning data from MPEG service information/program specific information (SI/PSI) tables for example, broadcast channel 43, 36 and 31, may include the following information shown in Table 1:

TABLE 1
Tuning Data

FREQUENCY: 647000000 (us-bcast: 43)
TSID: 0x0121
PROGRAM 1: 2.1 KCBS-HD
PROGRAM 2: 2.2 KCBS-SD
FREQUENCY: 605000000 (us-bcast: 36)
TSID: 0x0123
PROGRAM 3: 4.1 NBC-4LA
PROGRAM 4: 4.2 COZI-TV
FREQUENCY: 575000000 (us-bcast: 31)
TSID: 0x0125
PROGRAM 3: 5.1 KTLA-DT
PROGRAM 4: 5.2 Antenna
PROGRAM 5: 5.3 This TV

Table 2 below includes a portion of a Rovi channel lineup that matches the MPEG table information. Along with the cable channel number, table 2 also has ATSC channel numbers. A link between the two portions of information (e.g., Rovi channel lineup and OTA MPEG tables) is employed using the ATSC channel numbers. For example, KCBSHD is ATSC channel number 2.1 and it is linked to the physical channel information in the MPEG tables using the ATSC channel number 2.1 which is PROGRAM 1 in the RF channel 43. The channel map may be built using cable channel numbers, such that a user would be able to watch KCBSHD by tuning to 1002.

TABLE 2
Portion of Rovi Channel lineup for a
cable company (e.g., Cox ®) in U.S. Zip Code 92612:

| Cable | Cable | | ATSC |
|---|---|---|---|
| Channel | Channel | Cable | channel |
| Name | Number | Source ID | number |
| KCBSHD | 1002 | 11110 | 2.1 |
| KNBCHD | 1004 | 11287 | 4.1 |
| KTLA5CW | 1005 | 11711 | 5.1 |
| KCETHD | 1006 | 9870 | 28.1 |
| KABCHD | 1007 | 11099 | 7.1 |
| WORLD | 814 | 13502 | 50.4 |

In one embodiment, the video programs may be augmented with programs received over IP. In case the same program is available both from OTA and IP, the provider would have a choice to make one of them available to the user. This choice would be based on the business rules which take cost, performance, and quality into account. In the case of video received over IP, the physical channel information or tuning parameters are equivalent to a URI, where that program channel is available. The content provider knows this information and they would be able to make use of it appropriately.

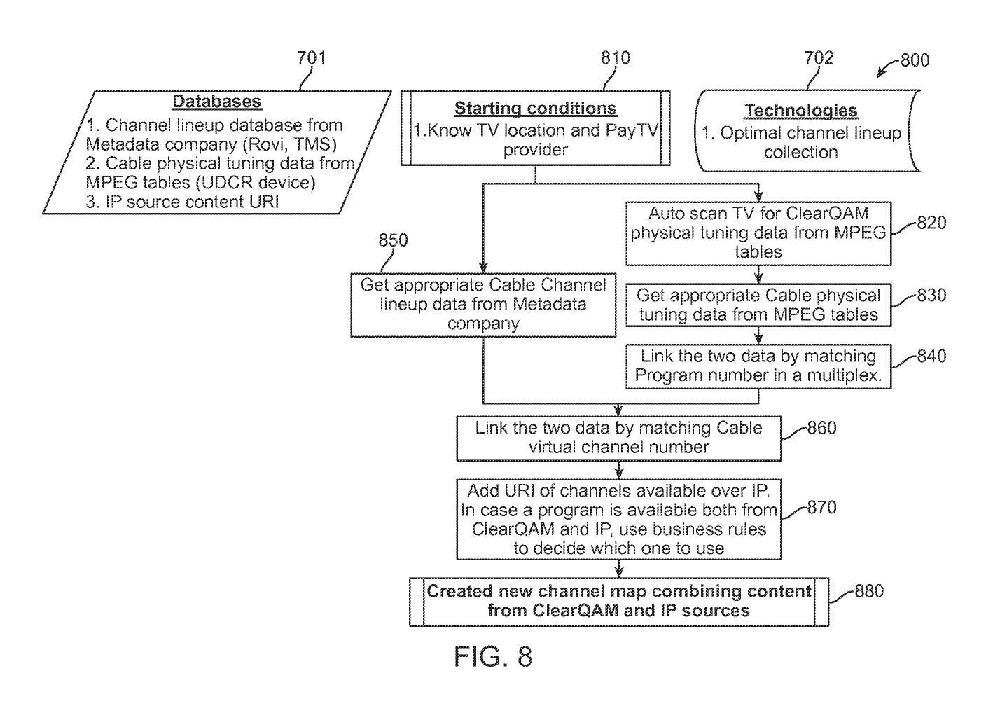

FIG. 8 shows an example flow diagram 800 for combining programing from a Clear QAM (tuner) and IP, according to an embodiment. In one embodiment, the database 701 and technologies 702 are the same as in FIG. 7. The starting conditions 810 include knowing the electronic device (e.g., a TV) location and the pay TV provider (e.g., cable or satellite provider). In one example, in block 850 appropriate cable/satellite channel lineup data is obtained from a metadata company. In block 820, an auto-scan or physical tuning data is obtained using the electronic device based on MPEG tables. In block 830 the appropriate cable physical tuning data is obtained from MPEG tables (as described below). In block 840 different sets of data are linked by matching program number in a multiplex. In block 860 the two sets of data are linked by matching cable virtual numbers. In one embodiment, in block 870 URIs of channels available over IP are added. In case program is available both from ClearQAM and IP, business rules are used to decide which one to use. In block 880, the newly created channel map combining content from two different sources (i.e., ClearQAM and IP sources) is created.

In one example, MPEG table information below is obtained from scanning frequency 237 MHz (physical channel 26) from a ClearQAM TV, as:
Frequency: 237000000 (us-cable:26)
LOCK: qam256
PROGRAM 3: 0
PROGRAM 813: 0
PROGRAM 814: 0
PROGRAM 915: 6.1 KCET HD
PROGRAM 6201: 0
PROGRAM 35413: 6.2 KCET Ki
PROGRAM 44019: 63.1 KBEH ch
PROGRAM 45146: 0
PROGRAM 59132: 6.4 KCET-MH

There are 9 programs in this multiplex and the lines starting with PROGRAM: show information of each channel with a program number, ATSC channel number and channel name. Four of the examples (program numbers 915, 35413, 44019 and 59132) have ATSC channel numbers and channel names. The other remaining examples do not have any information of the channel. In one embodiment, the electronic device (e.g., TV) assigns local channel numbers to these programs (for example “26-813” for program 813).

The following data is the same MPEG table that is obtained from a Cable Card or similar device and it looks quite different. All programs (except one, program 6201, which is invisible to users) have cable channel numbers that are different from above.
Frequency: 237000000 (us-cable:26)
LOCK: qam256
PROGRAM 3: 3 COX3
PROGRAM 813: 387 V ME
PROGRAM 814: 814 WORLD
PROGRAM 915: 1006 (HD) KCET
PROGRAM 6201: 0
PROGRAM 35413: 811 KCET KIDS & FAM
PROGRAM 44019: 26 KBEH
PROGRAM 45146: 1 ONDEMAND BARKER
PROGRAM 59132: 812 KCET MHZ

All channels in the above examples are ClearQAM channels and can be received by the ClearQAM electronic device (e.g., TV). In one embodiment, channels are matched using the program numbers that are the same for both the tables. In one example, program number 814 is “WORLD” and this program number matches both the ClearQAM and Cable Card MPEG tables. After matching the program number, the corresponding cable channel number may be derived from the Cable Card MPEG table, and this channel number matches with the cable virtual channel number in the Rovi guide from Table 2 above. In one embodiment, the video programs may be augmented with programs received over IP.

In one embodiment, in case the same program is available both from OTA and IP, the provider would have a choice to make one of them available to the user. This choice may be based on the business rules that take cost, performance, and quality into account. In case of video received over IP, the physical channel information or tuning parameters are equivalent to a URI where that program channel is available. The content provider knows this information and is able to make use of it appropriately.

One or more embodiments further provide auto-programming. An electronic device (e.g., TV) may download the channel map when it is turned on, when the auto-program starts, or regularly with some defined time or event interval. The electronic device may match the virtual channel information to the physical tuning information acquired by its own auto-programming, or if the channel map is guaranteed accurate and up-to-date, it may skip auto-programming and use the channel map as-is.

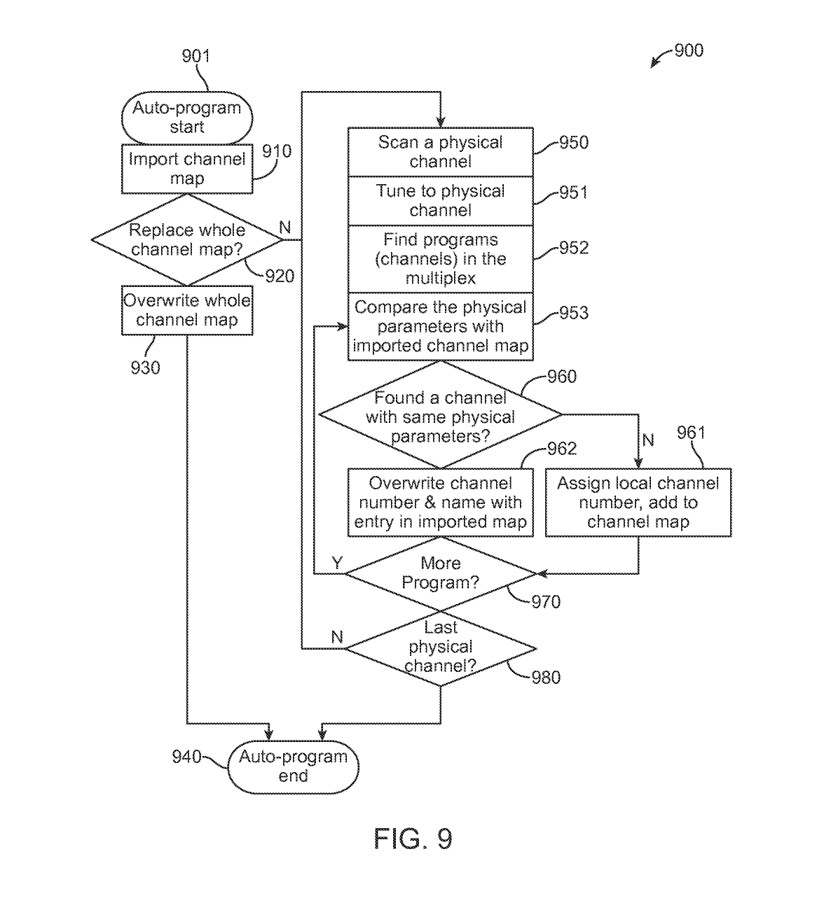

FIG. 9 shows an example flow diagram 900 for modified auto-programming of an electronic device (e.g., a TV set) with channel map replacement, according to an embodiment. In one embodiment, in block 901 the auto-programming function of the electronic device is started (e.g., automatically starts on power on, manually starts, etc.). In block 910, the channel map is imported (e.g., from another electronic device, from the cable/satellite company, etc.). In block 920, it is determined whether to replace the complete channel map or not. In one embodiment, if it is determined to replace the channel map, the flow proceeds to block 930 where the whole channel map is overwritten. If it is determined to no replace the whole channel map, the flow proceeds to block 950.

In block 950, a physical channel is scanned by the electronic device. In one embodiment, in block 951, the electronic device is tuned to a physical channel. In block 952, programs are searched to find programs (channels) in the multiplex. In block, 953 the physical parameters are compared with the imported channel map.

In block 960, it is determined whether a channel with the same physical parameters is found. If no channel with the same physical parameters is found, the flow proceeds to block 961. In block 961, a local channel number is assigned and added to the channel map. The flow then proceeds to block 970. If a channel with the same parameters is found, the flow proceeds to block 962 where the channel number and name are overwritten in an entry in the imported channel map.

In block 970, it is determined if further programming is required. If it is determined that further programming is required, the flow proceeds back to block 953, otherwise the flow proceeds to block 980. In block 980, it is determined whether the last physical channel has been reached in the flow. If the last channel has been reached, the flow proceeds to block 940 and the flow ends. Otherwise, the flow proceeds back to block 950.

In one embodiment, the electronic device (e.g., TV) can replace the whole channel map when the data is guaranteed accurate and up-to-date. If not, the electronic device may use the physical tuning parameters (physical channel number or frequency, and the program number) and replace the channel number and name with the same entry in the imported channel map.

In one example, auto programming is not performed (skipped) when the whole channel map is replaced by the imported data (the flow on the left of flow diagram 900). In the case where auto-programming is preferred (the flow on the right of flow diagram 900), the channel map data is compared with the imported data. For each digital channel found by scanning, its physical tuning parameters are compared with the values of all channels in the imported channel map.

In one example, when a channel is found in the imported map with the same physical parameters, this scanned channel is verified as one of the channels in the cable/satellite lineup. Then, the channel number and the channel name are replaced by the one from the imported channel map, so that the user may recognize them as “familiar” channels they see on the STB. EPG scheduling data will also be matched based on the virtual channel number from the imported map.

In one example, the auto-program software may obtain the first sample, and the imported channel map has the second sample. When the auto-programming software scans frequency 237 MHz and found program number 3, there is no channel number and channel name found. However, there is an entry with the same physical parameters (frequency 237 MHz and program number 3) in the second sample (imported channel map). As such, in one embodiment the auto-program software can detect the match in the physical parameter and assign the channel number (“3”) and the channel name (e.g., “COX3”) to this unknown channel found by scanning.

The embodiments may reduce cost for the users who can receive OTA programming, by combining content from various sources (RF cable and IP) into one easy to use user interface making it appealing to users. If there are multiple TVs in a home, all TV receiving devices (TV set or STB) can use the same channel-numbering scheme, which is easy to remember for users. For example, after watching a clear QAM channel with a living room STB, a user may watch the same channel in a second TV in a bedroom (without an STB) using the same channel number. Users will have more information on the clear QAM channels (channel name, program schedule information, and detailed information of each program), which they currently do not receive. The TV may skip the auto-programming (channel scan) process that is time-consuming, if there is a guaranteed source to import up-to-date channel map information. Additionally, if the external channel map were updated frequently, any changes to the channel map would be correctly reflected without having to perform a channel scan. The embodiments allow combining programming from RF cable and IP, and may be extended to include programming received over HDMI (from DTA) and IP using a similar approach.

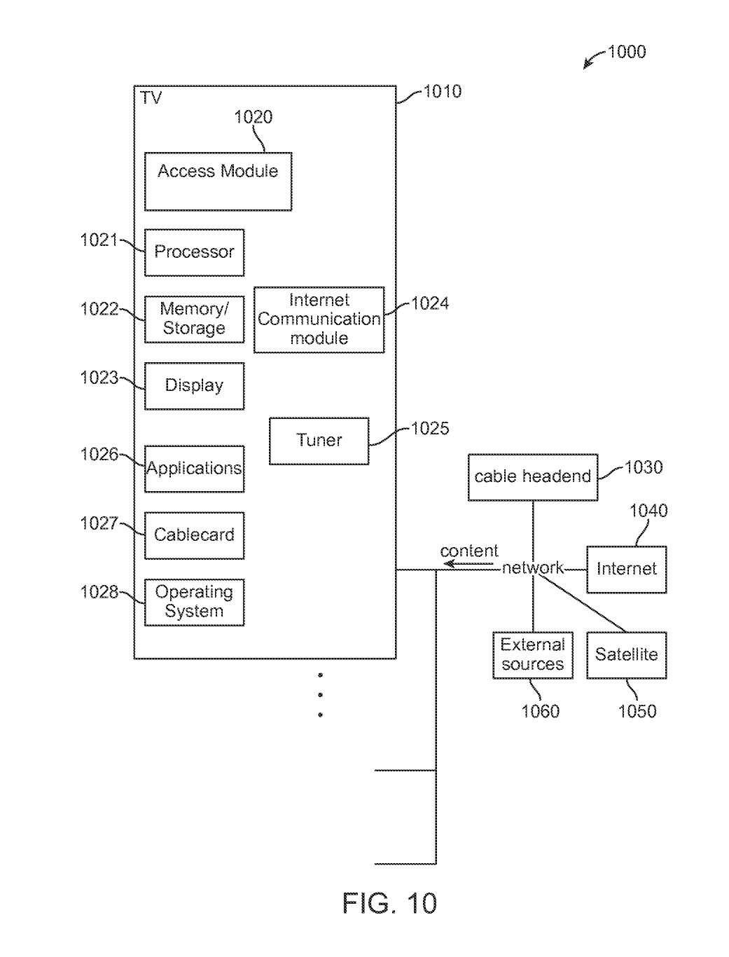

FIG. 10 shows a block diagram 1000 of a TV device 1010 in which embodiments are implemented in an access module, according to an embodiment. The TV device 1010 may be connected in a home or local network with other devices. In one embodiment, the TV device 1010 includes an access module 1020 that may include processes similar to the flow diagrams described above. In one embodiment, the TV device 1010 further includes a processor device 1021, a memory/storage device 1022, a display 1023, one or more applications 1026, an Internet communication module 1024, a tuner 1025, a cable card (or similar device) 1027, an operating system 1028, etc. In one example, the TV device 1010 may connected over a network to the cable headend 1030, the Internet 1040, a satellite 1050, external sources 1060, etc.

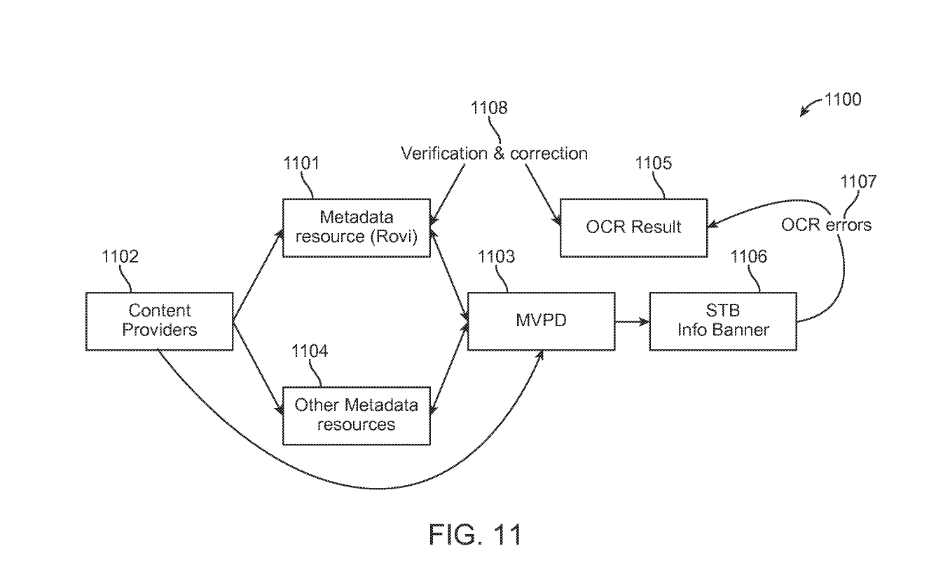

FIG. 11 shows an example data transmission flow 1100 in content generation and correction, according to an embodiment. The channel lineup and EPG generation is complex work, which involves multiple parties, including Multichannel video programming distributors (MVPD) 1103, content providers 1102 and metadata companies 1101 and 1104 (other metadata resources). Metadata Companies, such as Rovi, collect information from content providers 1102, such as Disney® or CBS®, and MVPDs 1103, such as COX® or DIRECTV®, to build their channel lineup and EPG, including the STB information banner 1106. During this complicated data processing workflow, potential problems, including mismatching and data that is out-of-time, may be introduced. It is necessary to have a mechanism to verify and correct this metadata recourse.

In one embodiment, OCR is performed on using a live TV screen capture where the OCR result 1105 is used as extracted information to verify and correct 1108 metadata. The STB information banner 1106 shown on a TV, includes channel number, channel name and program name, which is obtained from the MVPD 1103. In one example, the MVPD gains information from multiple metadata companies 1101 and 1104 and content providers 1102, then combines the data together and gives them to their STBs, which transmit and show the information on TVs. Through the data transmission, information provided by the MVPD 1103 may also not be the same as that from the original content provider. Moreover, OCR results 1105, which are used in verification and correction 1108, may include OCR errors 1107. From the diagram 1100, it can be seen that both sides of the verification and correction 1108 may not be error-free, which causes difficulties in solving error problems.

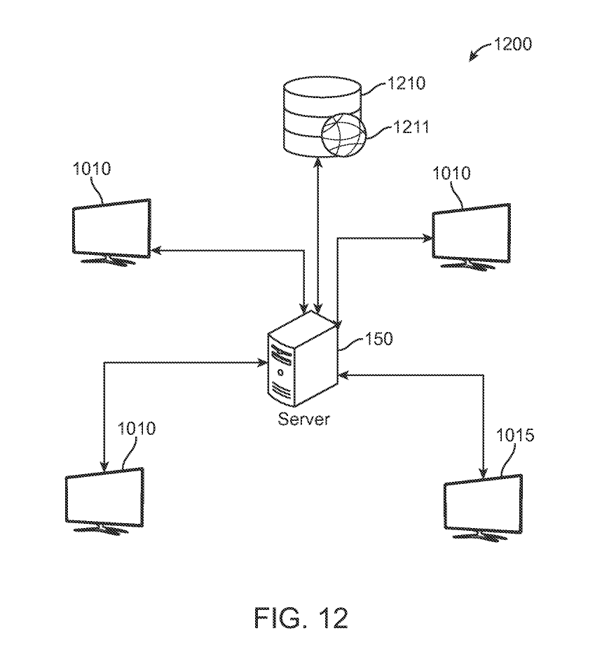

FIG. 12 shows an example distributed system 1200 that may implement one or more embodiments. In one example, the distributed system 1200 includes a server or service 150 and TV devices 1010 and electronic device 1015 (e.g., a TV device, computing device, portable device, monitor device, projector device, etc.), content provider 1210 and Internet, cable or satellite connectivity 1211. In one embodiment, in the distribution system 1200, distributed TV devices 1010 and 1015 send OCR results to the server or service 150, which collects the information and performs lineup and EPG validation and correction.

In one example, the server or service 150 communicates using the metadata that contains the TV lineup and EPG data. In one embodiment, for both lineup correction and EPG correction, Zip code and MVPD of the TV device need to be known. In one example, the required information may be obtained through user registration or other techniques.

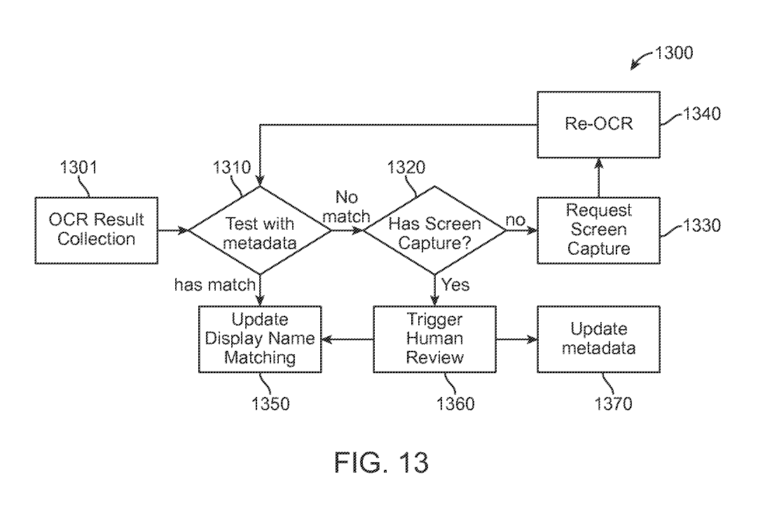

FIG. 13 shows a flow diagram 1300 for lineup validation and correction, according to an embodiment. In block 1301, OCR result collection is performed. In one embodiment, a channel lineup result, including channel number and channel name, is collected using OCR from a distributed TV device (e.g., electronic device 1010, 1015, FIG. 12). In block 1310, it is determined if the OCR result matches metadata by testing the OCR result with metadata. In one embodiment, it is assumed that OCR for a channel number has a reliable accuracy, and the channel number is used to identify a channel and the corresponding channel name is obtained from metadata. In one example, if a match is made (e.g., exact or within a selected probability), the flow proceeds to block 1350 where the display name that is found to be a match is updated. If no match was found, the flow proceeds to block 1320.

In block 1320, it is determined if the screen has been captured (or scanned). If the screen has been captured, the flow proceeds to block 1360 where a user review is triggered (e.g., with a screen or voice prompt). In one embodiment, when there is a lineup error discovered by previous processing, a user review is required before actual updating the metadata. If the screen has not been captured yet, the flow proceeds to block 1330. In block 1330, a request for a screen capture is made. In one example, if the channel name does not match with the metadata, the corresponding screen capture will be pulled from the TV for verification, if applicable.

In block 1340, if the channel name doesn't match with the metadata and corresponding screen capture is uploaded, the server or service 150 (FIG. 12) will perform OCR with the image by itself and compare the new OCR result with the one previously obtained from the TV device. In block 1370, after the user review is triggered, the display name matching is updated. In one example, a build or update a match between the display channel name and the channel name in a database is performed, if there is any difference. In one example, the update may be triggered after user review or automatic channel name matching in block 1310.

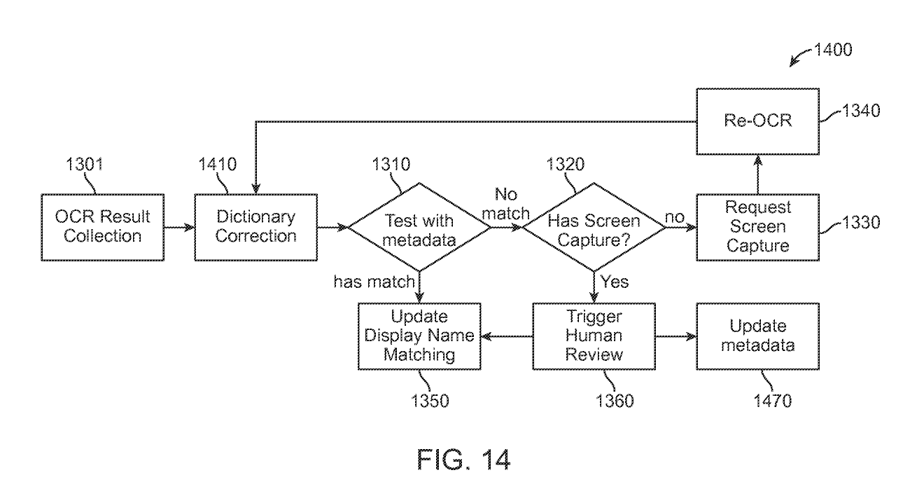

FIG. 14 shows a flow diagram 1400 for EPG validation and correction, according to an embodiment. The flow diagram 1400 may also be viewed as a general workflow for correcting any information that can be collected through a display screen capture OCR. In block 1301, the OCR results are collected as in flow 1300. In one example, the program name is recognized through screen capture OCR and collected from a distributed TV device. In one embodiment, for EPG correction, a timestamp may be sent from the TV or obtained from the server or service 150 (FIG. 12) directly.

In block 1410, a dictionary is used to correct the program name. In one example, the dictionary lookup may be performed by the TV device or the server or service 150. In block 1310, it is determined whether a match is made with the result of the dictionary corrected name and the metadata. In one example, matching the program name from the OCR result with the program name from the metadata for the corresponding channel and time period is performed. If there is not a match with the program name, the flow proceeds to block 1320. In block 1320, it is determined if the screen has been captured (or scanned). If the screen has not been captured, the flow proceeds to block 1330 where a request is made for a screen capture. If the program name doesn't match with the metadata, the corresponding screen capture will be pulled from the TV for verification, if applicable. In block 1340, if the program name does not match with the metadata and the corresponding screen capture is uploaded, the server or service 150 (FIG. 12) will perform an OCR with the image by itself and compare the new OCR result with the one previously obtained from the TV device.

If there was a match, the flow proceeds to block 1350 where the matched name is updated. In one example, a match between the displayed program name and the program name in metadata is built or updated, if there is any difference. This processing may be triggered after a user review or automatic program name matching in block 1310. In block 1360, a user review is triggered. In one example, when there is an EPG error verified by previous processing, a user/human review is required before actual updating the metadata. In one embodiment, a user or system administrator may easily make the decision through the screen capture image. In block 1470, the EPG is then updated in metadata.

In one embodiment, a dictionary is helpful for program name correction. The dictionary applied may include the union set of words and abbreviations from all possible program names. In one embodiment, the correction processing may include the following. The name is first pre-processed by tailing the program name. In one example, special characters are removed and only letters and numbers are reserved in the program name. In one implementation, all the letters are changed to upper case. If the program name includes multiple words, the words are corrected one by one. In one embodiment, the closest matches are found for each word. In one example, the closest word may be found through calculation of distance between two words; various algorithms may be applied for calculating the distance. One example includes implementing Levenshtein distance. Levenshtein distance may be adopted in word similarity calculations. Some similar character pairs are assigned a distance less than 1. The pairs including, but not limited in [(D,O), (8,B), (1, I), (O, 0), (2,Z), (B,D), (R,H),(B,E), (Ni, M),(13, B)]. In one implementation, for different MVPDs, different strategies may be used. For example, matching may need to be right-to-left or only take a part of the words into consideration. The reason for using right-to-left matching is that the right part of the words may be clearer and more reliable on the TV screen; meanwhile the left part may overlap with other signs or words for some MVPDs. One reason for cutting the word length is that a use of predefined regions on the TV screen are used for channel name, channel number or program name to improve OCR correctness, however, when the word length is very large, only a certain part of the word may fall into the region and may be recognized through OCR. These strategies may be very flexible due to the screen format and applied OCR technologies.

In one embodiment, a predefined threshold is used in decision making of match or non-match. If there is a display name in metadata that has a distance to the collected display name that is shorter than the threshold, then it will be considered a match. In one example, the threshold may be a value or a ratio. For instance, when the predefined threshold is two (2), the distance between word A and word B is 1, then A is a match of B. On the other hand, when the threshold is a ratio, such as 0.2, for a length of word A being ten (10), the distance between A and B is two (2), then word A and B are considered to match each other.

In one example, combining the words together is implemented to check whether it can be matched to a real program name. This is helpful when there are multiple possible words that match the OCR name. By combining the individual words, a decision may be made on the whole name. The differences between regular spell check and approaches of one or more embodiments are:
1. Due to the nature of OCR, it is possible that multiple characters are recognized as one and also one character is recognized as more than one. For example, “NicJr” may be recognized as “McJr” by OCR and needs to be converted back to “NicJr”.
2. Semantic mapping: The word knowledge may be extracted from program names if possible; for example, basketball and NBA should map with each other. The connection between synonyms and related terms may be used in semantic mapping. The size of the EPG and lineup data is smaller than that of dictionary for regular spell checking. This can make corrections more efficient than regular spell checks by one or more embodiments.
3. Idea of divide and conquer, a program name may be divided to single words to correct, and then the individual words may be combined together with the knowledge of actual program names. For example, for a TV show “How I met your mother” may have an OCR result such as “How I met y0ur mather”. In this case, y0ur and mather can be corrected separately, and then may be combined to the show name

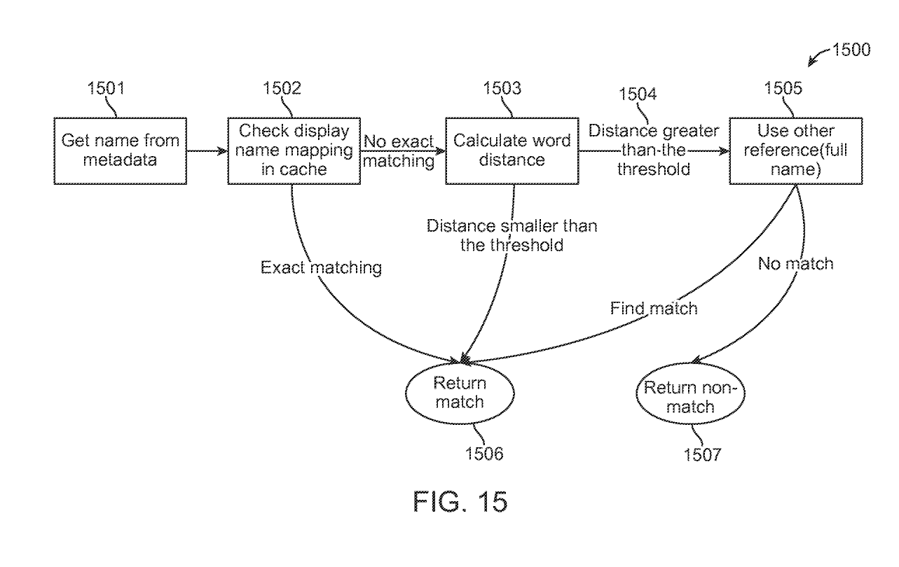

FIG. 15 shows a flow diagram 1500 for test matching the OCR result with metadata, according to an embodiment. Matching the OCR result or corrected OCR result with data resources is an important step in both lineup correction and EPG correction. The detail idea of metadata matching in lineup correction is as follows. In block 1501, the name (channel name or program name) is obtained from the metadata. Since the channel number has a higher probability of being correct than the name, in one embodiment channel number is used to identify a channel. The channel name may be obtained through querying the channel by channel number. In one example, if the two channel names are exactly the same, they are considered to match each other; otherwise, the flow proceeds to block 1502. In the case of EPG, the program name may be obtained by querying the database through the combination of channel, time, MVPD and zip code.

In block 1502, the display name mapping is checked. In one example, if the two names are in the mappings, they are considered to match each other; otherwise, the flow proceeds to block 1503. In block 1503, the distance between the two words is calculated. This is similar to dictionary correction. In one example, Levenshtein distance is calculated for the two channel names. If the distance is smaller than the threshold, then the two names match each other. If greater than the threshold, the two are not exactly the same. The matching between the display name and the name is saved in the database. If the two words still not match, than the distance is greater than the threshold at 1504 and the flow proceeds to block 1505.

In block 1505, the full name or other reference with rich information is used to find a match. The two names may be completely different, but they are describing the same thing, for example they are different substrings of the full name. Fortunately, Rovi metadata has the full name of channel names. The idea here is to check whether the full name contains the collected display name. If so, the OCR name matches with the metadata and a mapping between the display name and the channel name in the database is built. Until this processing portion, if the decision for the OCR channel name is still a non-match, the final result of test with the database will be a “non-match” returned at 1507; otherwise, the result is a “match” and returned at 1506. For a program, this processing portion may use program category and program description for reference.

In one example, the “test with metadata” processing for EPG correction is similar to that of lineup correction. Program name may be obtained according to the MVPD, timestamp and channel number. The timestamp may be obtained from the TV directly or from the server or service, and converted to local time.

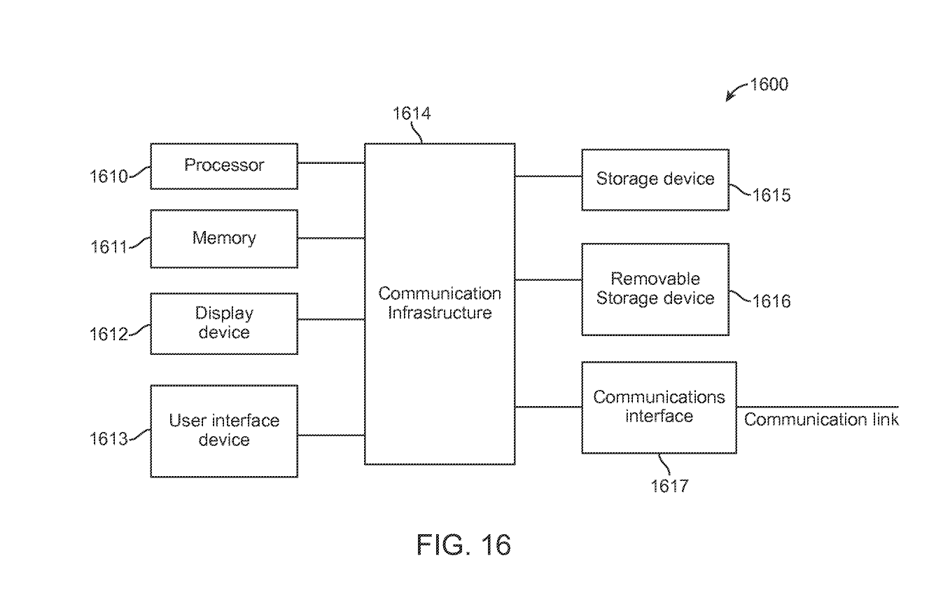

FIG. 16 is a high level block diagram showing a computing system 1600 comprising a computer system useful for implementing an embodiment. The computer system 1600 includes one or more processors 1610, and can further include an electronic display device 1612 (for displaying graphics, text, and other data), a main memory 1611 (e.g., random access memory (RAM)), storage device 1615, removable storage device 1616 (e.g., removable storage drive, removable memory module, a magnetic tape drive, optical disk drive, computer readable medium having stored therein computer software and/or data), user interface device 1613 (e.g., keyboard, touch screen, keypad, pointing device), and a communication interface 1617 (e.g., modem, a network interface (such as an Ethernet card), a communications port, or a PCMCIA slot and card). The communication interface 1617 allows software and data to be transferred between the computer system 1600 and external devices. The system further includes a communications infrastructure 1614 (e.g., a communications bus, cross-over bar, or network) to which the aforementioned devices/modules are connected as shown.

Information transferred via communications interface 1617 may be in the form of signals such as electronic, electromagnetic, optical, or other signals capable of being received by communications interface, via a communication link that carries signals and may be implemented using wire or cable, fiber optics, a phone line, a cellular phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

Embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of one or more embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

What is claimed is:

1. A method comprising:
identifying a first headend that is coupled to one or more receivers; and
assigning the one or more receivers to a particular priority set of a plurality of priority sets for the identified first headend.

2. The method of claim 1, wherein the plurality of priority sets comprise at least a first priority set and a second priority set.

3. The method of claim 2, wherein one or more receivers assigned to the first priority set send information to a server device based on one or more of: a first periodic event, and upon change in channel map information.

4. The method of claim 3, wherein one or more receivers assigned to the second priority set send status information to the server device based on a second periodic event, and one or more receivers assigned to a third priority set send status information to the server device based on a third periodic event.

5. The method of claim 4, wherein for each headend connected to the server, receivers are added to priority sets in order of priority based on reaching membership limits for each priority set.

6. The method of claim 5, wherein receivers in the first priority set that fail to send the information to the server and receivers in the second priority set that fail to send the status information to the server are removed from a receiver database, and receivers that are determined to be unreliable may be moved to another priority set level.

7. The method of claim 6, further comprising:
presenting a collection of video programming from one or more sources comprising one or more of radio frequency (RF) sources and Internet Protocol (IP) sources in a single viewing interface comprising a navigator or electronic programming guide (EPG) displayed using an electronic device.

8. The method of claim 7, further comprising:
creating a single channel map based on compiling information from one or more of Metadata sources, moving picture expert group (MPEG) tables and uniform resource identifiers (URIs);
wherein the single viewing interface uses channel numbers assigned by multichannel video programming distributors (MVPDs) or a standard with channel numbers that the electronic device receives from RF sources.

9. The method of claim 8, wherein a channel up/down received instruction shows a next channel regardless of content source on the single viewing interface, and a new channel map is importable from another electronic device or cloud storage.

10. The method of claim 9, wherein for multiple video sources for a same video program, navigation within the single viewing interface to a video program is based on a set of rules.

11. The method of claim 7, further comprising:
dynamically validating and correcting commercial television metadata resources for information that is recognized from a display of the electronic device, wherein the information comprises one or more of channel number, channel name and program name.

12. The method of claim 11, further comprising:
dynamically generating a map between a display name provided by a metadata resource and a live display name from a television client;
wherein dynamically validating and correcting commercial television metadata resources for the information that is recognized from the display of the electronic device comprises performing optical character recognition (OCR).

13. The method of claim 12, wherein dynamic correction and validation comprises:
collecting live OCR data from a client device;
correcting an OCR result using one or more dictionaries;
validating the corrected OCR result with a metadata resource;
pulling a screen capture from a client device for re-OCR on a server; and
generating a map for inconsistent terms in the metadata resource.

14. A system comprising:
one or more headend devices; and
one or more receivers coupled to the one or more headends,
wherein the one or more receivers identify a first headend that is coupled to the one or more receivers, and forward information based on the identified first headend to a service, wherein the service assigns the one or more receivers to a particular priority set of a plurality of priority sets for the identified first headend.

15. The system of claim 14, wherein the plurality of priority sets comprise at least a first priority set and a second priority set, and the one or more receivers assigned to the first priority set send information to the service based on one or more of: a first periodic event, and upon change in channel map information.

16. The system of claim 15, wherein one or more receivers are assigned to the second priority set and send status information to the service based on a second periodic event, and one or more receivers assigned to a third priority set send status information to the service based on a third periodic event.

17. The system of claim 16, wherein for each headend connected to the service, receivers are added to priority sets in order of priority based on reaching membership limits for each priority set, and receivers in the first priority set that fail to send the information to the service and receivers in the second priority set that fail to send the status information to the service are removed from a receiver database, and receivers that are determined to be unreliable may be moved to another priority set level.

18. The system of claim 17, further comprising
an electronic device coupled to a particular receiver, wherein the electronic device displays a single viewing interface that receives a collection of video programming from one or more sources comprising one or more of radio frequency (RF) sources and Internet Protocol (IP) sources, wherein the single viewing interface comprises a navigator or electronic programming guide (EPG).

19. The system of claim 18, wherein one of the service and the electronic device creates a single channel map based on compiling information from one or more of Metadata sources, moving picture expert group (MPEG) tables and uniform resource identifiers (URIs);
wherein the single viewing interface uses channel numbers assigned by multichannel video programming distributors (MVPDs) or a standard with channel numbers that the electronic device receives from RF sources; and
wherein a channel up/down received instruction shows a next channel on the single viewing interface regardless of content source, and a new channel map is importable from another electronic device or cloud storage.

20. The system of claim 19, wherein for multiple video sources for a same video program, navigation within the single viewing interface to a video program is based on a set of rules.

21. The system of claim 18, wherein the electronic device dynamically validates and corrects commercial television metadata resources for information that is recognized from a display of the electronic device, and the information comprises one or more of channel number, channel name and program name.

22. The system of claim 21, wherein the service dynamically generates a map between a display name provided by a metadata resource and a live display name from the electronic device, wherein dynamically validating and correcting commercial television metadata resources for the information that is recognized from the display of the electronic device comprises performing optical character recognition (OCR).

23. The system of claim 22, wherein dynamic correction and validation comprises:
the electronic device collecting live OCR data from the display;
the service:
corrects an OCR result using one or more dictionaries;
validates the corrected OCR result with a metadata resource;
pulls a screen capture from the electronic device for re-OCR; and
generates a map for inconsistent terms in the metadata resource.

24. A non-transitory computer-readable medium having instructions which when executed on a computer perform a method comprising:
identifying a first headend that is coupled to one or more receiver devices; and
assigning one or more receivers to a particular priority set of a plurality of priority sets for the identified first headend.

25. The medium of claim 24, wherein the plurality of priority sets comprise at least a first priority set and a second priority set, and one or more receivers assigned to the first priority set send information to a server device based on one or more of: a first periodic event, and upon change in channel map information.

26. The medium of claim 25, wherein one or more receivers assigned to the second priority set send status information to the server device based on a second periodic event, and one or more receivers assigned to a third priority set send status information to the server device based on a third periodic event, for each headend connected to the server, receivers are added to priority sets in order of priority based on reaching membership limits for each priority set, receivers in the first priority set that fail to send the information to the server and receivers in the second priority set that fail to send the status information to the server are removed from a receiver database, and receivers that are determined to be unreliable may be moved to another priority set level.

27. The medium of claim 26, further comprising:
presenting a collection of video programming from one or more sources comprising one or more of radio frequency (RF) sources and Internet Protocol (IP) sources in a single viewing interface comprising a navigator or electronic programming guide (EPG) displayed using an electronic device; and
creating a single channel map based on compiling information from one or more of Metadata sources, moving picture expert group (MPEG) tables and uniform resource identifiers (URIs);
wherein the single viewing interface uses channel numbers assigned by multichannel video programming distributors (MVPDs) or a standard with channel numbers that the electronic device receives from RF sources.

28. The medium of claim 27, wherein a channel up/down received instruction shows a next channel regardless of content source on the single viewing interface, and a new channel map is importable from another electronic device or cloud storage, and for multiple video sources for a same video program, navigation within the single viewing interface to a video program is based on a set of rules.

29. The medium of claim 27, further comprising:
dynamically validating and correcting commercial television metadata resources for information that is recognized from a display of the electronic device, wherein the information comprises one or more of channel number, channel name and program name; and
dynamically generating a map between a display name provided by a metadata resource and a live display name from a television client;
wherein dynamically validating and correcting commercial television metadata resources for the information that is recognized from the display of the electronic device comprises performing optical character recognition (OCR).

30. The medium of claim 29, wherein dynamic correction and validation comprises:
collecting live OCR data from a client device;
correcting an OCR result using one or more dictionaries;
validating the corrected OCR result with a metadata resource;
pulling a screen capture from a client device for re-OCR on a server; and
generating a map for inconsistent terms in the metadata resource.
